(19) United States
(12) Patent Application Publication
(10) Pub. No.: US 2014/0290973 A1
(43) Pub. Date: Oct. 2, 2014

(54) PNEUMATIC TOOL HAVING A ROTATABLE OUTPUT SHAFT

(71) Applicant: Johnson LIN, Tainan City (TW)

(72) Inventor: Johnson LIN, Tainan City (TW)

(21) Appl. No.: 14/190,376

(22) Filed: Feb. 26, 2014

(30) Foreign Application Priority Data
Mar. 27, 2013 (TW) 102205644
Apr. 16, 2013 (TW) 102206904

(51) Int. Cl. B25B 21/02; B25F 5/02

(52) U.S. Cl. CPC B25B 21/02; B25F 5/02
USPC 173/104; 173/218

(57) ABSTRACT

a pneumatic tool includes a plastic tool body, a metal front hood connected to and disposed in front of the plastic tool body so as to define an accommodating space therebetween, and an air motor disposed within the accommodating space. The air motor includes a front bearing unit and a rear bearing unit disposed behind the front bearing unit. At least one of the front and rear bearing units is connected fixedly to the metal front hood. The air motor further includes a cylinder body disposed between the front and rear bearing units and connected integrally to the one of the front and rear bearing units, and a rotor disposed rotatably within the cylinder body.

### CROSS-REFERENCE TO RELATED APPLICATION

This application claims priority to Taiwanese Application No. 102205644, filed on Mar. 27, 2013, and Taiwanese Application No. 102206904, filed on Apr. 16, 2013.

### BACKGROUND OF THE INVENTION

1. Field of the Invention

This invention relates to a pneumatic tool, and more particularly to a pneumatic tool having an output shaft that can be rotated pneumatically.

2. Description of the Related Art

A conventional pneumatic tool includes a metal outer shell, an air motor disposed within the metal outer shell, an air control device for guiding air into the air motor, and an impact mechanism driven by the air motor to rotate. Since all components of the conventional pneumatic tool are made of metal, the conventional pneumatic tool is relatively heavy, and thus is difficult to hold up. To solve this problem, an improved pneumatic tool is designed to have a lightweight outer shell that includes a graspable plastic tool body and a metal front hood disposed in front of and connected to the plastic tool body by bolts. The air motor and the impact mechanism are disposed within an accommodating space formed between the plastic tool body and the metal front hood. The air control device is disposed in the plastic tool body.

As such, since a portion of the outer shell is made of a plastic material, the improved pneumatic tool can be easily held up. However, during operation of the improved pneumatic tool, a very strong impact force is created, and is transmitted to the outer shell. Since a major portion of the outer shell is made of the plastic material that has a low hardness, in a situation where the plastic tool body is connected to the metal front hood by bolts, when subjected to an impact from the impact mechanism, the plastic tool body is deformed easily, thereby affecting adversely firm connection between the plastic tool body and the metal front hood. As a result, the components in the outer shell may be swayed so that the output torque of the improved pneumatic tool is reduced.

### SUMMARY OF THE INVENTION

The object of this invention is to provide a pneumatic tool that is configured such that the weight of the pneumatic tool can be reduced without adverse affection on the output torque of the pneumatic tool and firm connection between a plastic tool body and a metal front hood.

According to this invention, a pneumatic tool includes a plastic tool body, a metal front hood connected to and disposed in front of the plastic tool body so as to define an accommodating space therebetween, and an air motor disposed within the accommodating space. The air motor includes a front bearing unit and a rear bearing unit disposed behind the front bearing unit. At least one of the front and rear bearing units is connected fixedly to the metal front hood. The air motor further includes a cylinder body disposed between the front and rear bearing units and connected integrally to the one of the front and rear bearing units, and a rotor disposed rotatably within the cylinder body.

As such, since the cylinder body is connected integrally to the one of the front and rear bearing units, connection between the plastic tool body and the metal front hood is firm, and sway of the components in the plastic tool body and the metal front hood can be prevented. Hence, the pneumatic tool is lightweight, and can provide a greater output torque.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is a partly exploded perspective view of the first preferred embodiment of a pneumatic tool according to this invention;

FIG. 2 is a schematic sectional view of the first preferred embodiment;

FIG. 3 is a sectional view of the first preferred embodiment;

FIGS. 4 and 5 are fragmentary perspective views of a plastic tool body of the first preferred embodiment;

FIG. 6 is a fragmentary exploded perspective view of the first preferred embodiment, illustrating a speed adjusting mechanism and an air control device;

FIG. 7 is a fragmentary top view of the first preferred embodiment, illustrating a positional relationship between the speed adjusting mechanism and the air control device when the pneumatic tool is in a reverse-rotation state;

FIG. 8 is a partly exploded perspective view of the second preferred embodiment of a pneumatic tool according to this invention;

FIG. 9 is a schematic sectional view of the second preferred embodiment;

FIG. 10 is a partly exploded perspective view of the third preferred embodiment of a pneumatic tool according to this invention;

FIG. 11 is a schematic sectional view of the third preferred embodiment;

FIG. 12 is a partly exploded perspective view of the fourth preferred embodiment of a pneumatic tool according to this invention; and

FIG. 13 is a schematic sectional view of the fourth preferred embodiment.

### DETAILED DESCRIPTION OF THE PREFERRED EMBODIMENTS

Before the present invention is described in greater detail in connection with the preferred embodiments, it should be noted that similar elements and structures are designated by like reference numerals throughout the entire disclosure.

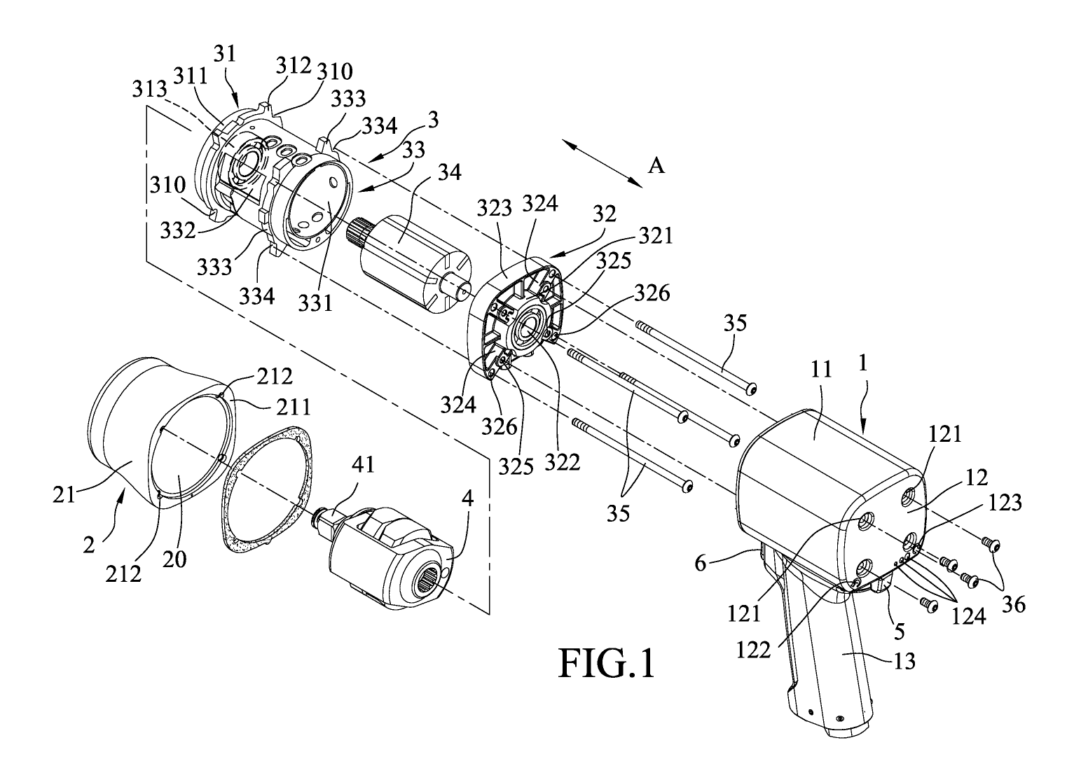

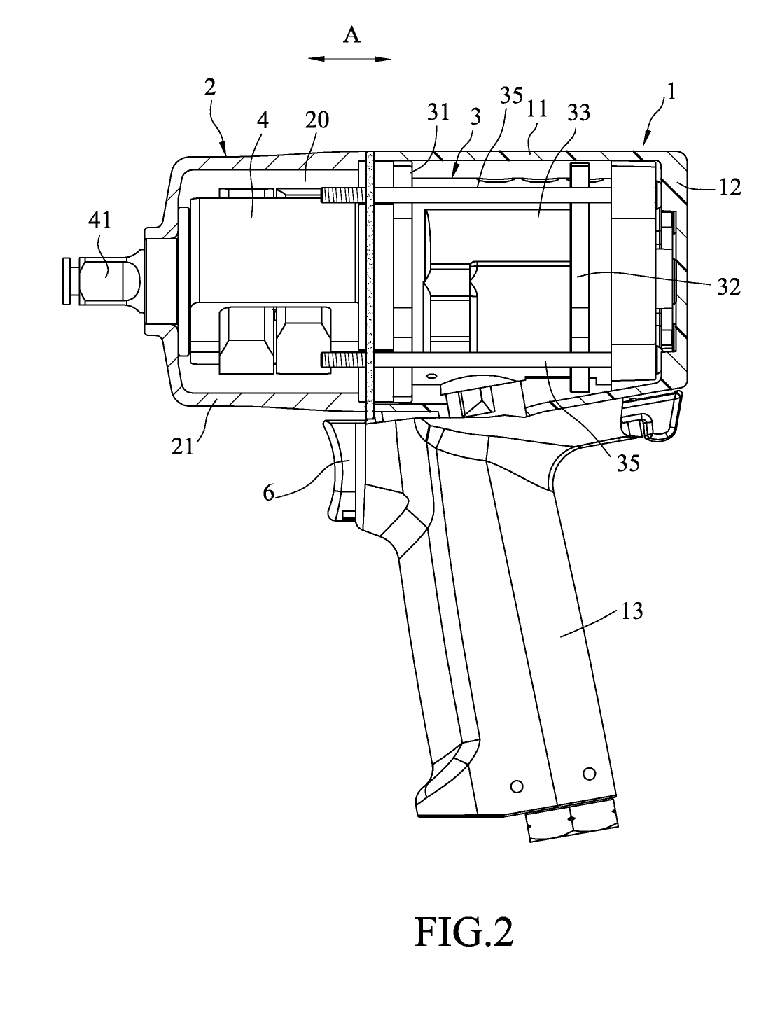

Referring to FIGS. 1, 2, and 3, the first preferred embodiment of a pneumatic tool according to this invention includes a plastic tool body 1, a metal front hood 2 connected to and disposed in front of the plastic tool body 2 so as to define an accommodating space 20 therebetween, an air motor 3 disposed within the accommodating space 20, an impact mechanism 4 disposed in the accommodating space 20 and in front of the air motor 3, an air control device 5 disposed in the plastic tool body 1 for guiding air into the air motor 3, and an intake device 5 for controlling flow of air into the air motor 3. The impact mechanism 4 includes an output shaft 41. Since the impact mechanism 4 and the intake device 6 are not pertinent to this invention, further description thereof will be omitted.

In this embodiment, the plastic tool body 1 is formed as one piece from a plastic material, and includes a rear surrounding wall 11 connected to the metal front hood 2 to define a rear half portion of the accommodating space 20, a rear end wall 12 connected integrally to and disposed behind the rear surrounding wall 11, and a handle 13 extending downwardly from the rear surrounding wall 11 and permitting the intake device 6 to be mounted thereto.

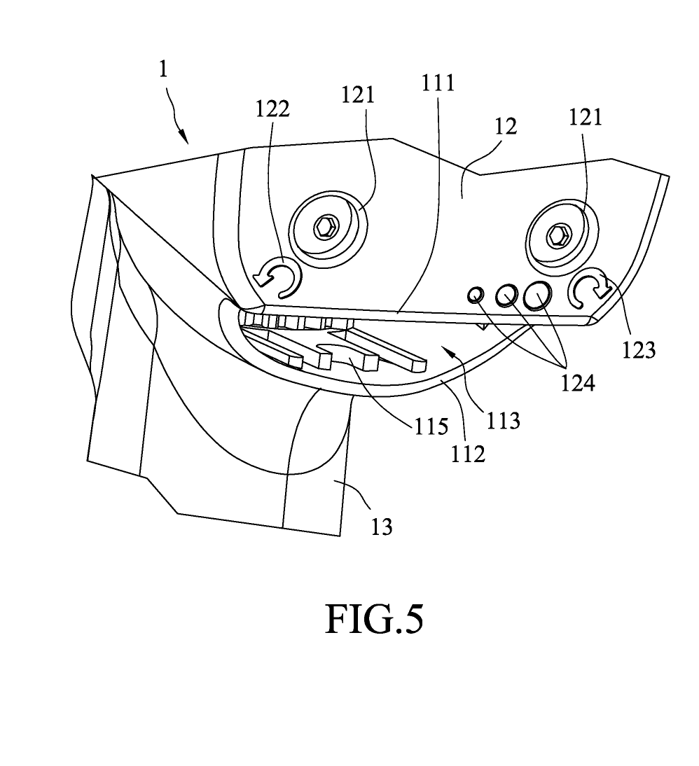

With further reference to FIG. 5, the rear surrounding wall 11 has an upper wall portion 111 and a lower wall portion 112 disposed under the upper wall portion 111 to define a mounting passage 113 therebetween. The upper wall portion 111 has a plurality of parallel positioning slots 114. The lower wall portion 112 has a semicircular first notch 115. The rear end wall 12 has four mounting holes 121 formed respectively in four corners thereof, a reverse-rotation mark 122 located at a left side portion thereof, a forward-rotation mark 123 located at a right side portion thereof, and a plurality of speed-representing marks 124 adjacent to the forward-rotation mark 123 and disposed between the reverse-rotation mark 122 and the forward-rotation mark 123. The handle 13 has an intake passage 131 in spatial communication with the mounting passage 113.

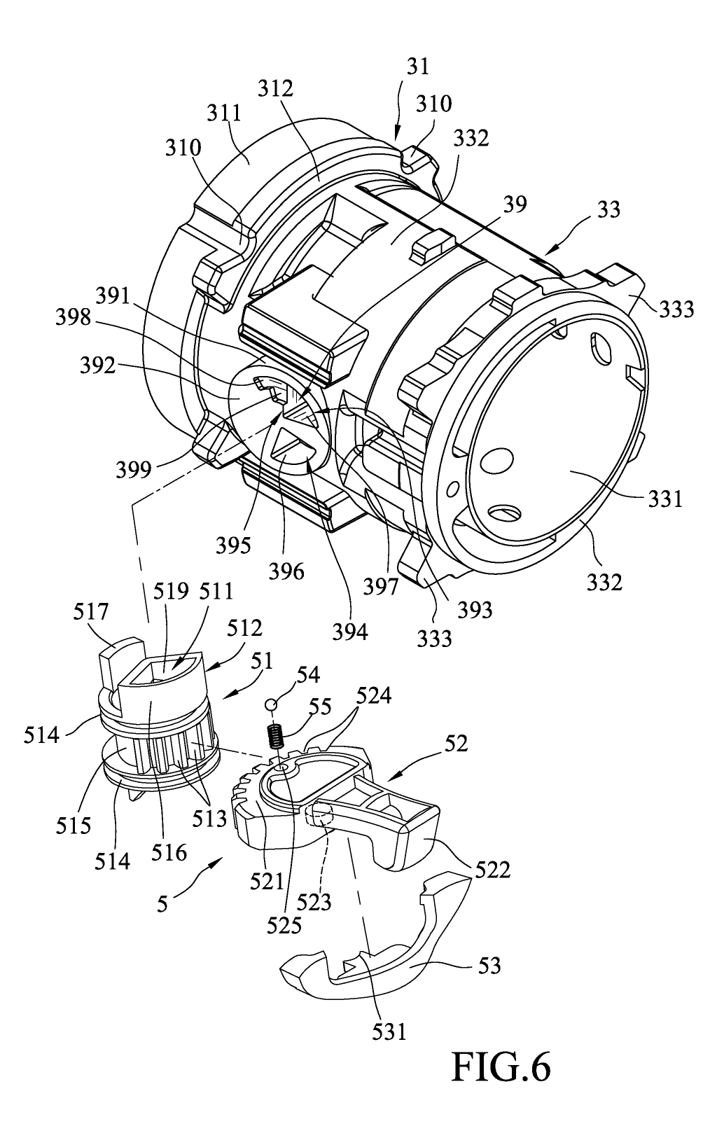

With particular reference to FIGS. 1, 3, and 6, the metal front hood 2 includes a front surrounding wall 21 defining a front half portion of the accommodating space 20. The front surrounding wall 21 has a looped rear end surface 211, and a plurality of first threaded holes 212 formed in the rear end surface 211.

The air motor 3 is disposed in the accommodating space 20, and is adjacent to the rear end wall 12 of the plastic tool body 1. In this embodiment, the air motor 3 includes a front bearing unit 31 connected fixedly to the metal front hood 2, a rear bearing unit 32 disposed behind the front bearing unit 31 and connected fixedly to the metal front hood 2, a cylinder body 33 disposed between the front and rear bearing units 31, 32 and connected integrally to the front bearing unit 31, a rotor 34 disposed rotatably within the cylinder body 33, and a speed adjusting mechanism 39 formed on the cylinder body 33. The front bearing unit 31 includes a front base wall 311 connected integrally to the cylinder body 33, a flange 312 extending radially and outwardly from the front base wall 311, and a front bearing 313 disposed in the front base wall 311. The flange 312 has a plurality of notches 310 aligned respectively with the first threaded holes 212 along an axial direction (A) of the cylinder body 33.

The rear bearing unit 32 is made of metal, and has a looped rear base wall 321, a rear bearing 322 disposed in the rear base wall 321, an outer peripheral wall 323 disposed around the rear base wall 321, and a plurality of connecting ribs 324 connected between the rear base wall 321 and the outer peripheral wall 323. Each rib 324 has a second threaded hole 325 adjacent to the rear base wall 321, and a rear connecting hole 326 adjacent to the outer peripheral wall 323. The second threaded holes 325 are aligned respectively with the mounting holes 121 in the plastic tool body 1 along the axial direction (A). The rear connecting holes 324 are aligned respectively with the notches 310 of the front bearing unit 31 along the axial direction (A).

In this embodiment, the cylinder body 33 and the front bearing unit 31 are formed as one piece from metal by casting. The cylinder body 33 has a cylindrical wall 332 defining an air chamber 331, and two projecting walls 333 extending respectively from two opposite sides of the cylindrical wall 332 away from each other. Each projecting wall 333 is adjacent to the rear bearing unit 32, and has two notches 334 aligned respectively with the rear connecting holes 326 along the axial direction (A). The rotor 34 is rotatable in response to flow of air into the air chamber 331 in the cylinder body 33.

In this embodiment, the air motor 3 further includes a plurality of front fasteners 35 and a plurality of rear fasteners 36. Each front fastener 35 is inserted forwardly through the corresponding rear connecting hole 326 in the rear bearing unit 32, the corresponding notch 334 in the cylinder body 33, and the corresponding notch 310 in the front bearing unit 31, and engages the corresponding first threaded hole 212 in the metal front hood 2. Each rear fastener 36 is inserted forwardly through the corresponding mounting hole 121 in the plastic tool body 1, and engages the corresponding second threaded hole 325 in the rear bearing unit 32.

The speed adjusting mechanism 30 includes a protrusion 391 extending downwardly from the cylindrical wall 332 of the cylinder body 33. The protrusion 391 has a downwardly facing abutment surface 392. The speed adjusting mechanism 391 further includes a forward-rotation passage 393 and a reverse-rotation passage 394 that extend through the cylindrical wall 332 and the protrusion 391. The forward-rotation passage 393 is sector-shaped, and has a forward-rotation inlet 395 formed in the abutment surface 392. The reverse-rotation passage 394 has a reverse-rotation inlet 396 formed in the abutment surface 392. The forward-rotation inlet 395 is stepped, and has a first inlet section 397, a second inlet section 398 narrower than the first inlet section 397, and a third inlet section 399 narrower than the first inlet section 397 and wider than the second inlet section 398.

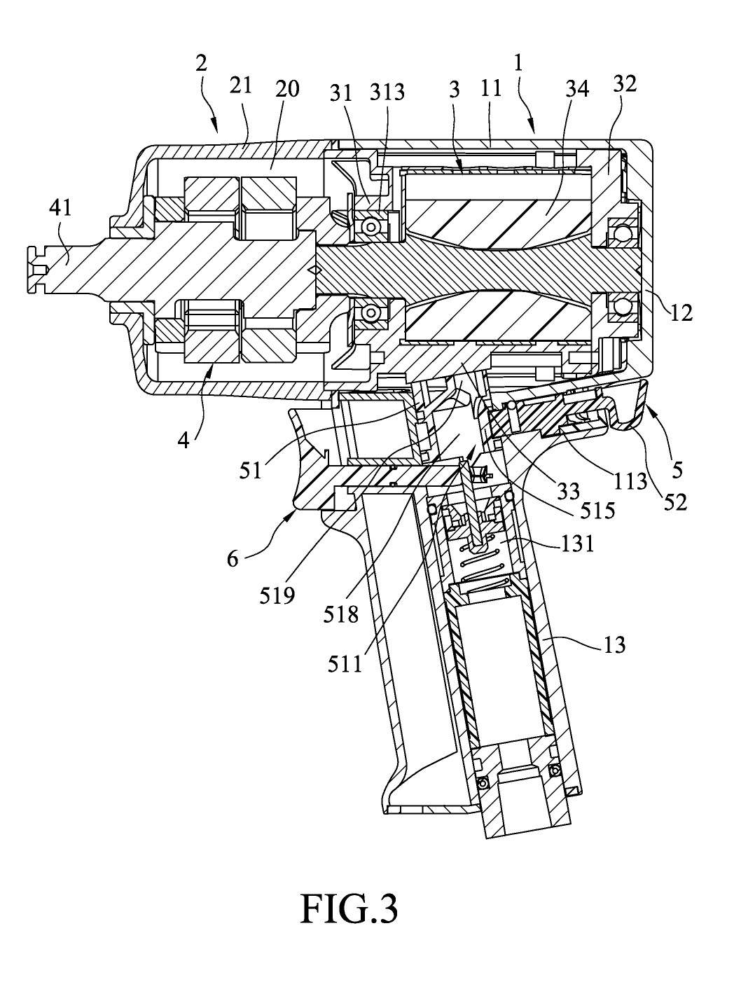

With particular reference to FIGS. 3, 5, and 6, the air control device 5 includes an air valve 51 disposed rotatably in the intake passage 14 and connected to the speed adjusting mechanism 391, a control member 52, a mounting seat 53 that connects the control member 52 to the plastic tool body 1 such that the control member 52 is confined in the intake passage 113, a positioning ball 54, and a spring 55 for biasing the positioning ball 54. The air valve 51 has a valve wall 512 defining an air control passage 511, and a plurality of first teeth 513 extending radially and outwardly from the valve wall 512 and disposed around a rotating axis thereof. The valve wall 512 has two ring wall portions 514 spaced vertically apart from each other, a cylindrical portion 515 connected between the ring wall portions 514 and having an outer diameter smaller than that of each ring wall portion 514, a connecting portion 516 extending upwardly from the upper ring wall portion 514, and a counterweight projection 517 extending upwardly from the upper ring wall portion 514 and abutting against the abutment surface 392 of the protrusion 391. In this embodiment, the first teeth 513 extend radially and outwardly from the cylindrical portion 515. The air control passage 511 has an intake section 518 formed in the cylindrical portion 515 and permitting entry of air, and a contracted section 519 formed in the connecting portion 516 and adjacent to the cylinder body 33. The air valve 51 is rotatable to align the contracted section 519 with a selected one of the forward-rotation passage 393 and the reverse-rotation passage 394, so as to control the rotational direction of the impact mechanism 4.

The control member 52 has a driving portion 521 and an operation portion 522 extending outwardly from the mounting passage 113 in the plastic tool body 1 . The driving portion 521 has a pivot stub 523, a plurality of second teeth 524 disposed around the pivot stub 523 and engaging the first teeth 513 of the air valve 51, and a ball receiving hole 525 permitting the positioning ball 54 and the spring 55 to be disposed therein, such that the positioning ball 54 is biased by the spring 55 to project partially from the ball receiving ball 525 to engage a selected one of the positioning slots 114. The mounting seat 53 is connected fixedly to the plastic tool body 1, e.g., by glue, is disposed in an end of the mounting passage 113 in the plastic tool body 1, and has a second notch 531 cooperating with the first notch 115 to form a pivot hole permitting the pivot stub 523 to be mounted rotatably therein.

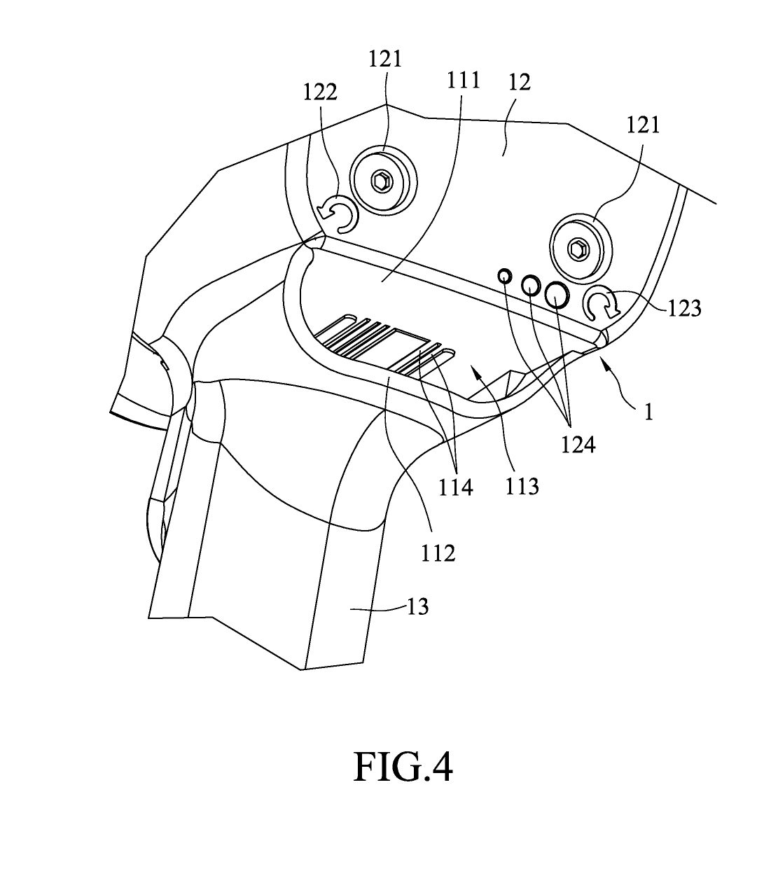

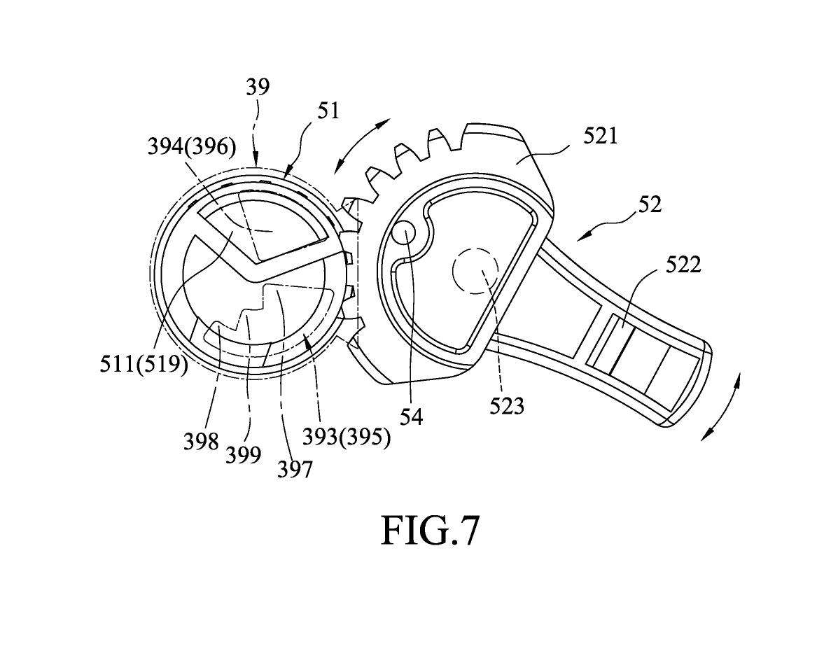

With particular reference to FIGS. 4, 5, 6, and 7, when the pneumatic tool is in a reverse-rotation state, the contracted section 519 of the air control passage 511 in the air valve 51 is aligned with the reverse-rotation inlet 396 of the reverse-rotation passage 394 in the speed adjusting mechanism 39. In this state, the operation portion 522 of the control member 52 is aligned with the reverse-rotation mark 122 of the plastic tool body 1, and the positioning ball 54 is engaged resiliently into one of the positioning slots 114 in the plastic tool body 1.

When it is desired to convert the pneumatic tool from the reverse-rotation state into a forward-rotation state, it is only necessary to rotate the operation portion 522 about the pivot stub 523 using the thumb of a hand gripping the handle 13. When the operation portion 522 is rotated to align with one of the speed-representing marks 124 of the plastic tool body 1, the pneumatic tool is in the forward-rotation state. In this state, the contracted section 519 of the air control passage 511 in the air valve 51 is aligned with (i.e., in fluid communication with) the forward-rotation inlet 395. Since the first, second, and third inlet portions 397, 398, 399 have different widths, when the contracted section 519 is aligned with the first inlet portion 397, the airflow rate and the output torque are maximum, and when the contracted section 519 is aligned with the second inlet portion 398, the airflow rate and the output torque are minimum.

During assembly, the impact mechanism 4 and the air motor 3 are assembled together, and are mounted into the front surrounding wall 21 of the metal front hood 2. Subsequently, the front bearing unit 31, the rear bearing unit 32, and the cylinder body 33 are connected fixedly to the metal front hood 2 by the front fasteners 35. At this time, the plastic tool body 1 is sleeved on the air motor 3, and is connected fixedly to the rear bearing unit 32 by the rear fasteners 36. Since the cylinder body 33 is connected fixedly to the metal front hood 2 by the front fasteners 35, if an impact force is created due to the impact operation of the impact mechanism 4, it cannot affect adversely firm connection between the plastic tool body 1 and the metal front hood 2. That is, the weight of the pneumatic tool can be reduced without adverse affection on the output torque of the pneumatic tool.

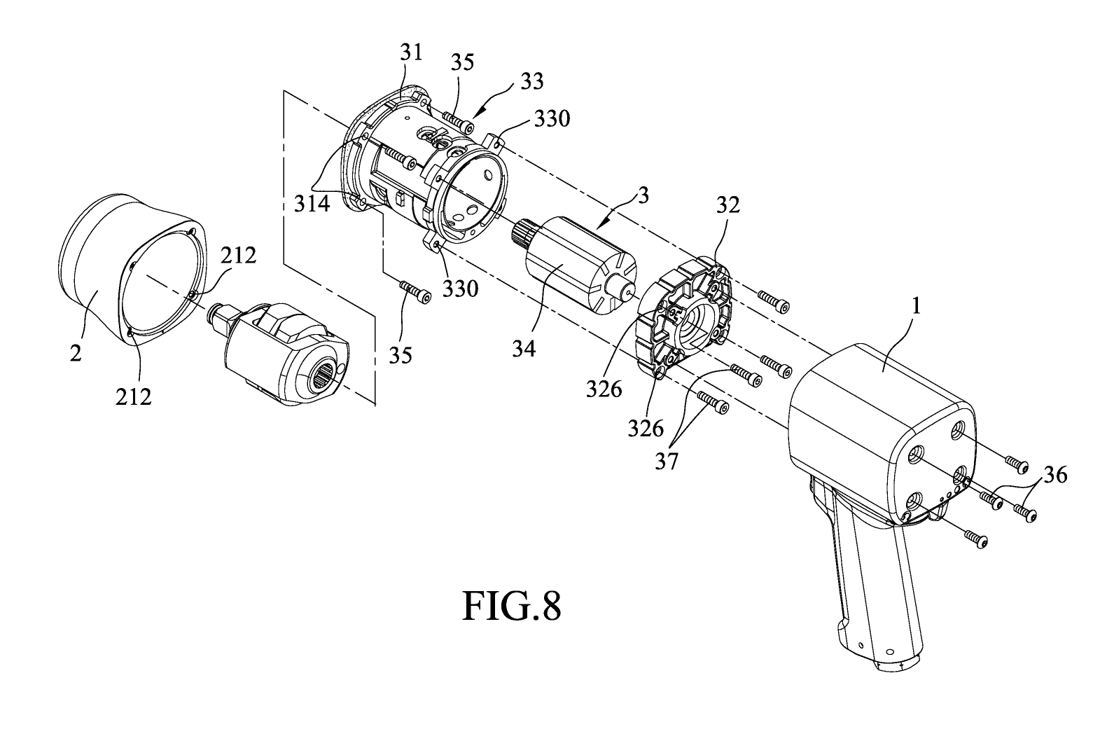

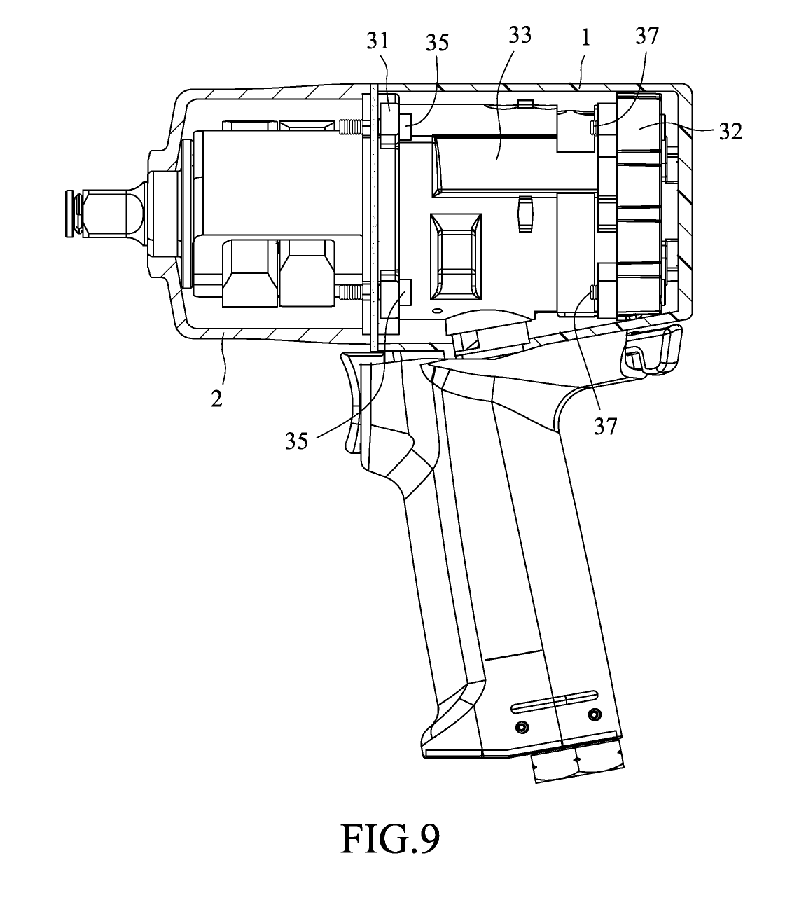

FIGS. 8 and 9 show the second preferred embodiment of a pneumatic tool according to this invention, which differs from the first preferred embodiment in that, the air motor 3 further includes a plurality of intermediate fasteners 37, and the cylinder body 33 further has a plurality of third threaded holes 330. The front bearing unit 31 has a plurality of front connecting holes 314 aligned respectively with the first threaded holes 212 in the metal front hood 2. During assembly, the front fasteners 35 are passed through the front connecting holes 314 in the front bearing unit 31, and are engaged into the first threaded holes 212 in the metal front hood 2 for connecting the front bearing unit 31 fixedly to the metal front hood 2. The intermediate fasteners 37 are passed through the rear connecting holes 326 in the rear bearing unit 32, and are engaged into the third threaded holes 330 in the cylinder 33 for connecting rear bearing unit 32 fixedly to the cylinder body 33. The plastic tool body 1 is connected fixedly to the rear bearing unit 32 by the rear fasteners 36. In this manner, the cylinder body 33 can be connected firmly to the metal front hood 2.

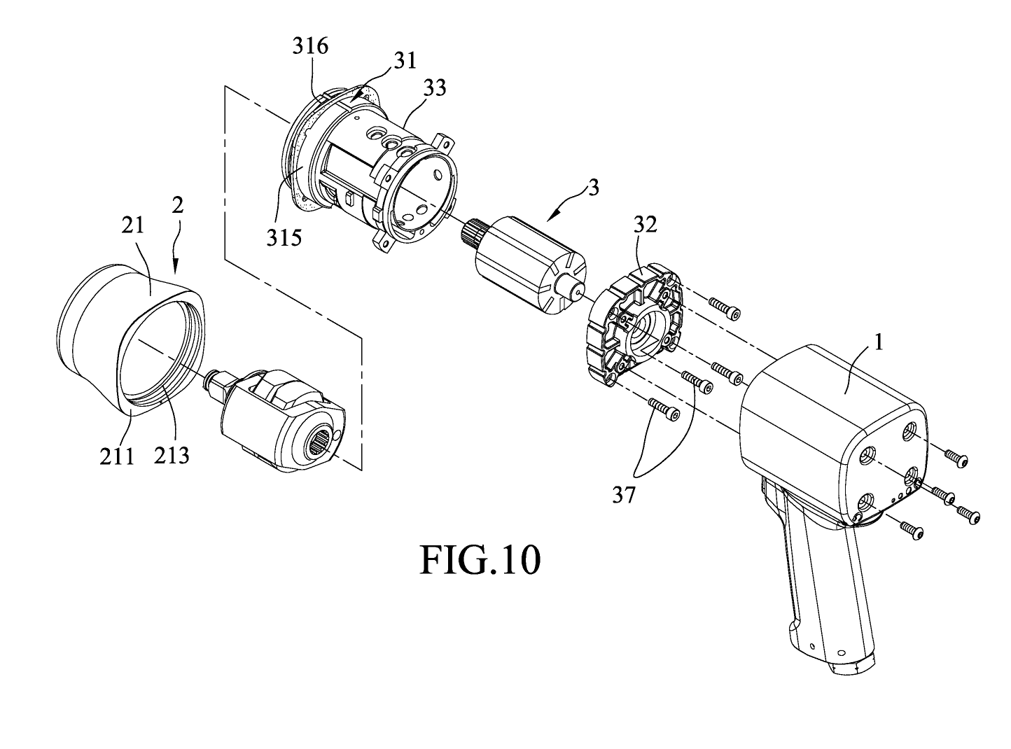

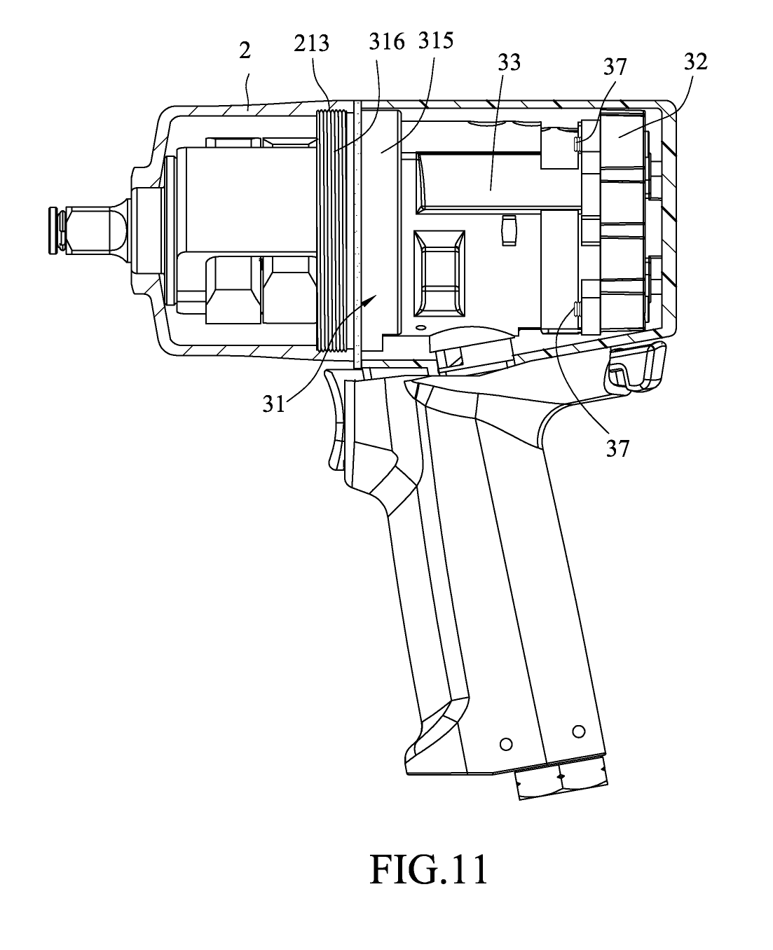

FIGS. 10 and 11 show the third preferred embodiment of a pneumatic tool according to this invention, which is similar to the second preferred embodiment. In this embodiment, the front bearing unit 31 are also formed integrally with the cylinder body 33, and has an annular outer surface 315. The annular outer surface 315 has an externally threaded portion 316 at a front end portion thereof. The front surrounding wall 21 has a looped rear end surface 211 and an internally threaded portion 213 that are disposed at a rear end thereof. The internally threaded portion 213 engages the externally threaded portion 316 of the front bearing unit 31 so that the front bearing unit 31 and the cylinder body 33 are connected firmly to the metal front hood 2. In addition, the rear bearing unit 32 is connected fixedly to the cylinder body 33 by the intermediate fasteners 37. As such, the air motor 3 is connected firmly to the metal front hood 2. Alternatively, the externally threaded portion 316 may be replaced with an externally threaded front end of the cylinder body 33.

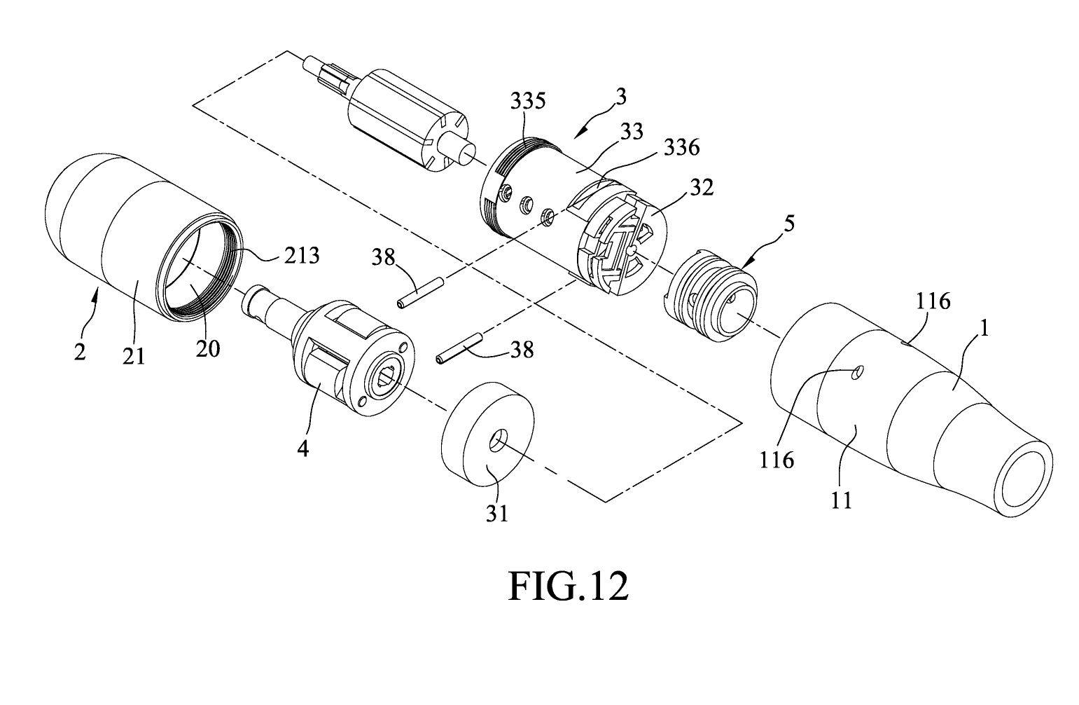

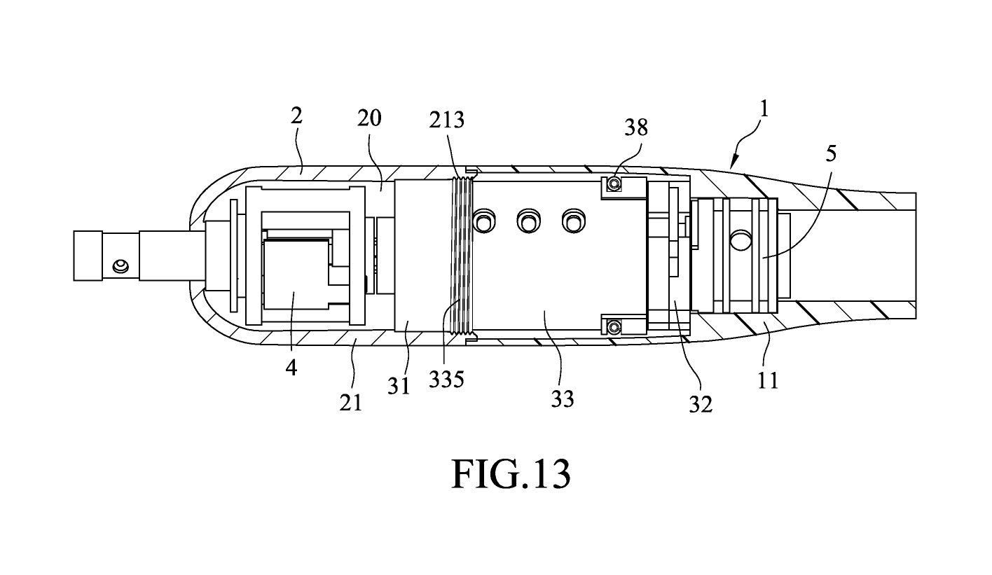

Referring to FIGS. 12 and 13, the fourth preferred embodiment of a pneumatic tool according to this invention includes a plastic tool body 1, a metal front hood 2, an air motor 3, an impact mechanism 4, and an air control device 5. The plastic tool body 1 includes a rear surrounding wall 11 defining the rear half portion of an accommodating space 20 and having two pairs of insert holes 116. The metal front hood 2 includes a front surrounding wall 21 defining the front half portion of the accommodating space 20 and having an internally threaded portion 213 at a rear end portion thereof . The air motor 3 includes a front bearing unit 31, a rear bearing unit 32, and a cylinder body 33 connected integrally to the rear bearing unit 32. The cylinder body 33 has an externally threaded portion 335 at a front end portion thereof, and an annular outer surface formed with two grooves 336. Each groove 336 is disposed between a respective pair of the insert holes 116. The air motor 3 further includes two insert pins 38. Each insert pin 38 extends through the respective groove 336 in the cylinder body 33 and into a corresponding pair of the insert holes 116, such that the cylinder body 33 is fixed relative to the plastic tool body 1.

During assembly, the front bearing unit 31 is first placed into the front surrounding wall 21 of the metal front hood 2. Next, the externally threaded portion 335 of the air motor 33 is engaged to the internally threaded portion 213 of the metal front hood 2, so that the air motor 3 is mounted firmly to the metal front hood 2. The plastic tool body 1 is connected to the cylinder body 33 of the air motor 3 by the insert pins 38. Although the structure of the air motor 3 and a connection relationship between the plastic tool body 1 and the air motor 3 are changed, the weight of the pneumatic tool still can be reduced without adverse affection on the output torque of the pneumatic tool and firm connection between the plastic tool body 1 and the metal front hood 2.

With this invention thus explained, it is apparent that numerous modifications and variations can be made without departing from the scope and spirit of this invention. It is therefore intended that this invention be limited only as indicated by the appended claims.

I claim:

1. A pneumatic tool comprising:
a plastic tool body;
a metal front hood connected to and disposed in front of said plastic tool body so as to define an accommodating space therebetween; and
an air motor disposed within said accommodating space and including a front bearing unit and a rear bearing unit disposed behind said front bearing unit, at least one of said front and rear bearing units being connected fixedly to said metal front hood, said air motor further including a cylinder body disposed between said front and rear bearing units and connected integrally to the one of said front and rear bearing units, and a rotor disposed rotatably within said cylinder body.

2. The pneumatic tool as claimed in claim 1, wherein said front bearing unit and said cylinder body form as one piece by casting.

3. The pneumatic tool as claimed in claim 2, wherein said air motor further includes a plurality of front fasteners extending through said rear bearing unit, said cylinder body, and said front bearing unit and threaded to said metal front hood.

4. The pneumatic tool as claimed in claim 3, wherein said air motor further includes a plurality of rear fasteners extending through said plastic tool body and threaded to said rear bearing unit.

5. The pneumatic tool as claimed in claim 2, wherein said air motor further includes a plurality of front fasteners and a plurality of intermediate fasteners, said front fasteners extending through said front bearing unit and being threaded to said metal front hood, said intermediate fasteners extending through said rear bearing unit and being threaded to said cylinder body.

6. The pneumatic tool as claimed in claim 5, wherein said air motor further includes a plurality of rear fasteners extending through said plastic tool body and threaded to said rear bearing unit.

7. The pneumatic tool as claimed in claim 2, wherein said metal front hood includes a front surrounding wall defining a front half portion of said accommodating space and having an internally threaded portion, and said front bearing unit has an externally threaded portion engaging said internally threaded portion of said metal front hood.

8. The pneumatic tool as claimed in claim 2, wherein said metal front hood includes a front surrounding wall defining a front half portion of said accommodating space and having an internally threaded portion, and said cylinder body has an externally threaded portion engaging said internally threaded portion of said metal front hood.

9. The pneumatic tool as claimed in claim 1, wherein said rear bearing unit and said cylinder body form as one piece by casting.

10. The pneumatic tool as claimed in claim 9, wherein said metal front hood includes a front surrounding wall defining a front half portion of said accommodating space and having an internally threaded portion, and said cylinder body has an externally threaded portion engaging said integrally threaded portion of said metal front hood.

11. The pneumatic tool as claimed in claim 10, wherein said plastic tool body includes a rear surrounding wall defining a rear half portion of said accommodating space, said rear surrounding wall having two pairs of insert holes, said cylinder body of said air motor having an annular outer surface formed with two grooves each disposed between a respective pair of said insert holes, said air motor further including two insert pins each extending through a respective one of said grooves and into a corresponding pair of said insert holes, such that said cylinder body is fixed relative to said plastic tool body.

12. The pneumatic tool as claimed in claim 1, wherein said plastic tool body includes a rear surrounding wall connected to said metal front hood, a rear end wall disposed behind said rear surrounding wall, and a handle extending downwardly from said rear surrounding wall, said rear surrounding wall having a mounting passage in spatial communication with said accommodating space, said handle having an intake passage in spatial communication with said accommodating space, said cylinder body of said air motor defining an air chamber, said air motor further including a speed adjusting mechanism formed on said cylinder body of said air motor, said speed adjusting mechanism including a forward-rotation passage and a reverse-rotation passage, said pneumatic tool further comprising an air control device and a pneumatic impact mechanism, said air control device including an air valve disposed in said intake passage in said plastic tool body and connected to said speed adjusting mechanism, and a control member operable to rotate said air valve, said air valve having an air control passage adapted to permit flow of air therethrough, said air valve being rotatable to align said air control passage with a selected one of said forward-rotation passage and said reverse-rotation passage, so as to control a rotational direction of said impact mechanism.

13. The pneumatic tool as claimed in claim 12, wherein said air valve further has a valve wall defining said air control passage, said valve wall having a plurality of first teeth disposed around a rotating axis thereof, said control member having a driving portion, and an operation portion extending outwardly from said mounting passage in said plastic tool body, said driving portion having a plurality of second teeth engaging said first teeth of said valve wall.

14. The pneumatic tool as claimed in claim 13, wherein said air control passage in said air valve of said air control device has an intake section adapted to permit entry of air, and a contracted section adjacent to said cylinder body, said speed adjusting mechanism of said air motor further including a protrusion having an abutment surface, said reverse-rotation passage extending through said cylinder body and said protrusion and having a reverse-rotation inlet formed in said abutment surface, said forward-rotation passage extending through said cylinder body and said protrusion and having a forward-rotation inlet formed in said abutment surface, said forward-rotation inlet having three inlet sections of different widths, said air valve being operable to connect fluidly with a selected one of said three inlet sections.

15. The pneumatic tool as claimed in claim 14, wherein said rear surrounding wall of said plastic tool body further has an upper wall portion and a lower wall portion disposed under said upper wall portion to define said mounting passage therebetween, said upper wall portion having a plurality of positioning slots, said control member of said air control device having a ball receiving hole, said air control device further including a positioning ball disposed in said ball receiving hole, and a spring biasing said positioning ball to project partially from said ball receiving hole to engage a selected one of said positioning slots.

16. The pneumatic tool as claimed in claim 15, wherein said lower wall portion of said rear surrounding wall of said plastic tool body has a first notch, said control member of said air control device further having a pivot stub, said air control device further including a mounting seat that is disposed fixedly on said plastic tool body and that connects said control member to said plastic tool body, said mounting seat having a second notch that cooperates with said first notch to form a pivot hole permitting said pivot stub to be mounted rotatably therein.

17. The pneumatic tool as claimed in claim 16, wherein said rear end wall of said plastic tool body has a reverse-rotation mark, a forward-rotation mark, and a plurality of speed-representing marks adjacent to said forward-rotation mark and disposed between said reverse-rotation mark and said forward-rotation mark, said operation portion of said control member being operable to align with a selected one of said reverse-rotation mark and said speed representing marks.

18. The pneumatic tool as claimed in claim 17, wherein said valve wall of said air valve has two ring wall portions spaced vertically apart from each other, a cylindrical portion connected between said ring wall portions and defining said intake section of said air control passage, and a connecting portion defining said contracted section of said air control passage, said connecting portion abutting against said abutment surface of said protrusion of said cylinder body, said first teeth extending radially and outwardly from said cylindrical portion.

19. The pneumatic tool as claimed in claim 18, wherein said valve wall of said air valve further has a counterweight projection extending from one of said ring wall portions and abutting against said abutment surface of said protrusion.
